(19) United States
(12) Patent Application Publication
(10) Pub. No.: US 2008/0130620 A1
(43) Pub. Date: Jun. 5, 2008

(54) METHOD AND SYSTEM FOR COLLISION AVOIDANCE

(75) Inventors: Peijuan Liu, Patatine, IL (US); Xiang Chen, Rolling Meadows, IL (US); Ravindra P. Moorut, Barrington, IL (US); Floyd D. Simpson, Lake Worth, FL (US); Dominic M. Tolli, Libertyville, IL (US)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/674,504

(22) Filed: Feb. 13, 2007

Related U.S. Application Data
(60) Provisional application No. 60/868,032, filed on Nov. 30, 2006.

(51) Int. Cl. H04B 7/212

(52) U.S. Cl. 370/347

(57) ABSTRACT

The invention concerns a method (600) and device (100) for collision avoidance. The method can include the step of—in a multi-mode device (100) —conducting (630) a communication in accordance with an 802.16 communications protocol in which the 802.16 communication protocol communication includes only listening frames (530). The method can also include the step of conducting (640) in the multi-mode device another communication in accordance with a Bluetooth communications protocol that supports extended synchronous connection-oriented mode. The method can also include the step of arranging (640) transmissions of the Bluetooth communication to avoid collisions with transmissions of the 802.16 communication.

### CROSS-REFERENCE TO RELATED APPLICATIONS

The present application claims the benefit of U.S. Provisional Application Ser. No. 60/868,032, filed Nov. 30, 2006, which is hereby incorporated by reference herein.

### BACKGROUND OF THE INVENTION

1. Field of the Invention

The present invention concerns limiting collisions and more particularly, limiting collisions between a short range wireless system and a wide area wireless system.

2. Description of the Related Art

In recent years, mobile communications devices have been developed in which such devices operate in accordance with various wireless protocols. For example, many handsets are configured to operate in a code division multiple access (CDMA) network and include an accompanying Bluetooth transceiver to permit a user to engage in a hands-free conversation. These handsets may be referred to as multi-mode communication devices, or simply multi-mode devices.

Multi-mode devices that support operations in accordance with the Institute for Electrical and Electronics Engineers (IEEE) standard 802.16 and that include Bluetooth transceivers are currently being developed. One possible frequency band for the 802.16 standard runs from 2.496 GHz to 2.69 GHz, while one possible frequency allocation for Bluetooth is from 2.4 GHz to 2.4835 GHz. In a typical scenario for this type of a device, the user of the multi-mode device may use a Bluetooth headset while engaged in a Voice over Internet Protocol (VoIP) call. Harmonious coexistence of these two transmissions, however, cannot be achieved in the radio frequency (RF) layer in view of the compact size of the multi-mode device and the close proximity of the operating spectrum. In particular, harmful interference will arise in the multi-mode device when one technology transmits while the other attempts to receive.

### SUMMARY OF THE INVENTION

The present invention concerns a method and system for collision avoidance. The method can include the step of—in a multi-mode device—conducting a communication in accordance with an 802.16 communications protocol in which the 802.16 communication protocol communication includes only listening frames. The method can also include the steps of conducting in the multi-mode device another communication in accordance with a Bluetooth communications protocol that supports extended synchronous connection-oriented mode and arranging transmissions of the Bluetooth communication to avoid collisions with transmissions of the 802.16 communication.

The method can also include the step of requesting from a base station that supports the 802.16 communication a cluster of frames having a designated number of the listening frames. The method can further include the step of receiving from the base station a grant of the cluster of frames in which the cluster of frames includes three listening frames, each being approximately five milli-seconds in duration. The listening frames may include a downlink subframe and an uplink subframe, and the method can further include the step of receiving downlink burst and uplink burst allocations respectively in the downlink subframe and the uplink subframe of the listening frames. In one arrangement, the cluster of frames may include a single downlink burst allocation and a single uplink burst allocation. As an example, the downlink and uplink burst allocations may be periodically fixed for future clusters of frames.

The listening frames may also include a set-up portion. In one arrangement, arranging transmissions of the Bluetooth communication to avoid collisions with transmissions of the 802.16 communication can include the steps of reading the set-up portion of a first listening frame and based on this reading, determining a listening frame designation and starting the Bluetooth transmission a predetermined time after the beginning of the first listening frame. For example, the predetermined time can be approximately 6.25 milli-seconds, approximately 8.75 milli-seconds, approximately 11.25 milli-seconds or approximately 13.75 milli-seconds. In another arrangement, the Bluetooth communication may include a cycle time of approximately 7.5 milli-seconds, of which approximately 1.25 milli-seconds is occupied by a transmission slot and a receive slot.

Also, the multi-mode device may communicate with an accessory over the Bluetooth communications protocol and the multi-mode device is designated as a master. In this case, the method may include the steps of determining whether the multi-mode device is the master of the relationship between the multi-mode device and the accessory and switching the multi-mode device to the master if the multi-mode device is not designated as such to ensure that the multi-mode device is the master when the multi-mode device communicates with the accessory.

The invention also concerns another method of collision avoidance. The method can include the steps of—at a base station that supports 802.16 communications—receiving from a multi-mode device through an 802.16 communication a request for a cluster of frames having only a predetermined number of listening frames and granting the request for the cluster of frames in which the cluster of frames includes three listening frames. The method may also include the step of allocating uplink bursts and downlink bursts in the listening frames of the cluster of frames to permit the multi-mode device to arrange the transmissions of an extended synchronous connection-oriented Bluetooth communication to avoid collisions with the 802.16 communication.

In one arrangement, allocating the uplink and downlink bursts may include allocating a single downlink burst allocation and a single uplink burst allocation in the cluster of frames. As another example, the downlink and uplink burst allocations are periodically fixed for future clusters of frames.

The present invention also concerns a multi-mode device for collision avoidance that can include a transceiver capable of conducting an 802.16 communication having only listening frames and a transceiver capable of conducting an extended synchronous connection-oriented Bluetooth communication. The device can also include a collision avoidance module coupled to the first and second transceivers in which the collision avoidance module arranges transmissions of the Bluetooth transceiver to avoid collisions with transmissions of the 802.16 transceiver. The multi-mode device may also include suitable software and circuitry to carry out any of the processes described above.

The present invention also concerns a base station that supports 802.16 communications. The base station can include a transceiver that receives from a multi-mode device through an 802.16 communication a request for a cluster of frames having only a designated number of listening frames and a generating module. The generating module can grant the request for the cluster of frames in which the cluster of frames includes three listening frames and can allocate uplink bursts and downlink bursts in the listening frames of the cluster of frames to permit the multi-mode device to arrange the transmissions of an extended synchronous connection-oriented Bluetooth communication to avoid collisions with the 802.16 communication.

As an example, allocating the uplink and downlink bursts can include allocating a single downlink burst allocation and a single uplink burst allocation in the cluster of frames, and the downlink and uplink burst allocations can be periodically fixed for future clusters of frames.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a usage scenario in accordance with an embodiment of the inventive arrangements;

FIG. 2 illustrates block diagrams of certain components in accordance with an embodiment of the inventive arrangements;

FIG. 3 illustrates a portion of an 802.16 communication frame in accordance with an embodiment of the inventive arrangements;

FIG. 4 illustrates a Bluetooth communication cycle in accordance with an embodiment of the inventive arrangements;

FIG. 5 illustrates a collision-free reference pattern in accordance with an embodiment of the inventive arrangements;

FIG. 6 illustrates a method for avoiding collisions in accordance with an embodiment of the inventive arrangements;

FIG. 7 illustrates several examples of decision points in accordance with an embodiment of the inventive arrangements; and

FIG. 8 illustrates a summary chart of the decision points of FIG. 7 in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein.

The term “multi-mode device” can be defined as any electronic device capable of receiving and/or transmitting two or more different communication signals, some of which may be in accordance with different communications protocols. The term “transceiver” can be any component or group of components that are capable of receiving and transmitting communications signals. A “collision” can mean any interference between at least two different communication signals due to simultaneous transmission or reception of the communication signals at a multi-mode device.

The term “approximate” or “approximately” can refer to the actual value modified by such term and any variations from that actual value so long as such variations do not interfere with minimizing collisions between two or more different communications. The term “transmission” can mean the actual transmission of a signal and/or the receipt of a signal. The term “listening frame” can refer to a frame in which the receiver or transceiver of the device receiving such a frame is active for at least a portion of that frame.

The invention concerns a method and device for collision avoidance. The method can include the step of—in a multi-mode device—conducting a communication in accordance with an 802.16 communications protocol in which the 802.16 communication protocol communication includes only listening frames. The method can also include the step of conducting in the multi-mode device another communication in accordance with a Bluetooth communications protocol that supports extended synchronous connection-oriented mode. The method can also include the step of arranging transmissions of the Bluetooth communication to avoid collisions with transmissions of the 802.16 communication. This process can improve a user's experience when the user is on, for example, a VoIP call on a wireless handset while using a Bluetooth headset that is wirelessly coupled to the handset.

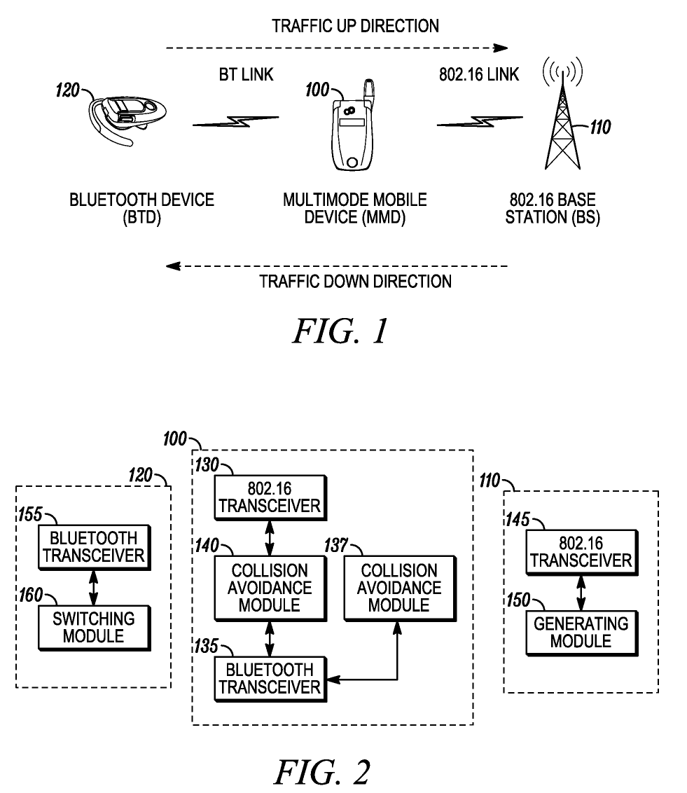

Referring to FIG. 1, an example of a usage scenario is presented. In this example, a multi-mode device 100 is communicating with a base station 110. In one arrangement, this communication can be an 802.16 communication, and the base station 110 can be referred to as an 802.16 base station. For purposes of the invention, the term “802.16 communication” or a “communication in accordance with an 802.16 communications protocol” can refer to wireless communications that comply with IEEE standard 802.16. As an example, an 802.16 communication can include wireless signals that operate in the frequency band from approximately 2.496 GHz to approximately 2.69 GHz.

The multi-mode device 100 may also be communicating with an accessory 120 over, for example, a Bluetooth communication link. A Bluetooth communication or a communication in accordance with a Bluetooth communications protocol can mean a wireless communication that is intended to have a short range, such as one measured in meters or feet, and that operates in accordance with specifications set forth by the Bluetooth Special Interest Group. As an example, the Bluetooth communication can operate in the frequency band of approximately 2.4 GHz to approximately 2.4835 GHz. The accessory 120 may be referred to as a Bluetooth accessory or device. In one particular example, the multi-mode device 100 may be conducting a VoIP call with the base station 110, while at the same time, the multi-mode device 100 may have an active communication link with the accessory 120.

Referring to FIG. 2, block diagrams of the multi-mode device 100, the base station 110 and the accessory 120 are shown. In one arrangement, the multi-mode device 100 can include an 802.16 transceiver 130, a Bluetooth transceiver 135, a device switching module 137 and a collision avoidance module 140. The 802.16 transceiver is capable of conducting an 802.16 communication that includes listening frames, while the Bluetooth transceiver 135 is capable of conducting an eSCO Bluetooth communication. As will be described below, the collision avoidance module 140, which can be coupled to both the 802.16 transceiver 130 and the Bluetooth transceiver 135, can arrange transmissions of the Bluetooth transceiver 135 to avoid collisions with the 802.16 transceiver 130. In addition, the device switching module 137 can ensure that the multi-mode device 100 is the master in its relationship with the accessory 120. The collision avoidance module 140 and the device switching module 137 can contain any suitable number of hardware and/or software components for carrying out any relevant processes.

In another arrangement, the base station 110 can include a transceiver 145 that can receive from the multi-mode device 100 through an 802.16 communication a request for a cluster of frames having a designated number of listening frames. The base station 110 can also include a generating module 150 that can grant the requested cluster of frames and can allocate uplink (UL) bursts and downlink (DL) bursts in the listening frames of the cluster of frames to permit the multi-mode device 100 to arrange the transmissions of the eSCO Bluetooth communication to avoid collisions with the 802.16 communication. Similar to the collision avoidance module 140, the generating module 150 can include any suitable number of hardware and/or software components for performing the functions described herein.

The accessory 120 can include a Bluetooth transceiver 155 for communicating with the multi-mode device 100. In addition, the accessory 120 can include a switching module 160. The switching module 160 can assist in ensuring that the multi-mode device 100 is designated as the master unit in the relationship between the multi-mode device 100 and the accessory 120. For example, when a communication between the accessory 120 and the multi-mode device 100 is initiated, the device switching module 137 can determine whether the device 100 is designated as the master of this relationship. If the device 100 is not the master, then the device switching module 137 can switch the role of the device 100 from the slave to the master, and this switch request can be accepted and processed by the switching module 160 of the accessory 120. Where appropriate, the switching module 160 can respond with slot offset. It is beneficial to have the multi-mode device 100 act as the master in this relationship, as the multi-mode device 100 is aware of the timing of the 802.16 communication.

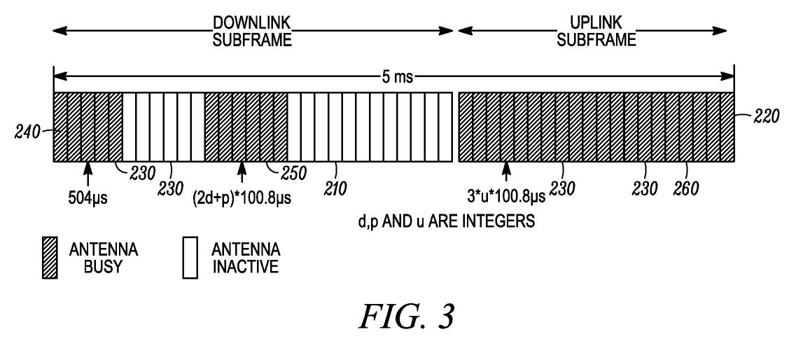

As is known in the art, an 802.16 communication includes a plurality of time division duplex (TDD) frames that are about 5 milli-seconds (ms) in duration. Referring to FIG. 3, an example of a portion of a frame 200 that is present in an 802.16 communication is shown (for brevity, transition times are not shown here). The frame 200 includes a DL subframe 210 and an UL subframe 220, and both the DL subframe 210 and the UL subframe 220 are made up of an integer number of orthogonal frequency division multiplexing (OFDM) or orthogonal frequency division multiple access (OFDMA) symbols 230, or simply, symbols 230. These symbols 230 are approximately 100.8 micro-seconds (μs) in length.

Part of the DL subframe 210 can include a set-up portion 240, which may include such things as a preamble, a frame control header (FCH), a DL-MAP and an UL-MAP. The multi-mode device 100 (see FIG. 1) can use this information to determine when and how to transmit and/or receive relevant packets in the frame 200 and possibly the next consecutive frame 200. In particular, the DL-MAP specifies the burst information for the current DL subframe 210, and the UL map provides burst information for the UL subframe 220 in the next consecutive frame 200. As such, the multi-mode device 100 is required to decode the set-up portion 240, and the set-up portion 240 may occupy about five to eight or more symbols 230. In this example, the set-up portion 240 is shown as occupying five symbols 230, which have been shaded and is equivalent to roughly 540 μs in time.

As alluded to earlier, the DL subframe 210 may include a DL burst 250, which is shown as being shaded in FIG. 3. As is known in the art, the minimum allocation unit is two symbols 230 by a subchannel, i.e., the minimum burst width is two symbols 230. A scheduler in the base station 110 (see FIG. 1) actually decides this allocation, and accordingly, from the time domain, the DL burst 250 may occupy 2*d (where d is an integer) symbols 230 anywhere within the available DL subframe 210, except for the symbols 230 taken up by the set-up portion 240. Furthermore, it is customary for the multi-mode device 100 to measure the pilot carriers in neighboring symbols 230 around the actual burst to carry out channel estimation, which will improve the decoding success rate of the desired burst.

In this example, this process causes two symbols 230 on either side of the actual burst to be occupied, which means that the DL burst 250 includes six symbols 230. To account for the total number of symbols 230 occupied by the DL burst 250, the value p, which reflects the number of symbols 230 used for the measurement of pilot carriers, is added to 2*d, which is shown in FIG. 3. The number of symbols 230 is then multiplied by 100.8 μs to show the total duration of the DL burst 250.

Similar to the DL subframe 210, the UL subframe 220 includes an UL burst 260, which is also shown in FIG. 3 as being shaded. Those of skill in the art will appreciate that the 802.16 standard specifies that the allocation of the UL burst 260 must span contiguous slots, where each slot is defined as three symbols 230 by a subchannel. Thus, the allocation is first done horizontally (over symbols 230) until reaching the edge of the UL subframe 220, which then continues from the first symbol 230 of the next subchannel. From the time domain perspective, the UL burst 260 may occupy 3*u symbols, where u is an integer dependent on the payload size and modulation and coding scheme associated with the UL burst 260. Accordingly, in the time domain, it is possible that the UL burst 260 may take up the entire UL subframe 220, if a VoIP packet is scheduled for this particular frame 200.

Overall, when both DL and UL transmissions are scheduled in the frame 200, one can see from the shaded portions that only a small gap is available for a competing transmission, such as Bluetooth, to take place. Moreover, the base station 110 randomly schedules the DL burst 250, which makes it even more difficult to avoid collisions between the 802.16 and Bluetooth communications.

As is known in the art, in Bluetooth, synchronous connection-oriented (SCO) mode and eSCO mode are two types of logic links for forming synchronous connections for supporting full duplex audio connections. For SCO mode, a high-quality voice (HV3) packet type has the longest duty cycle. This type of SCO packet carries 240 bits of payload in each direction every six time slots with forward error correction (FEC) encoding, which is equivalent to 3.75 ms worth of speech at a 64 kilobits per second (kbps) encoding rate. The transmissions are strictly periodic with a cycle time equal to six time slots, each one about 625 μs in duration. In addition, the slave (e.g., the accessory 120) responds in the slot immediately after the master (e.g., the multi-mode device 100) addresses to it. Therefore, two consecutive slots are always occupied out of every six slots. Following the Bluetooth transmission activity, about 2.5 ms of idle time remains in the cycle time for the SCO mode.

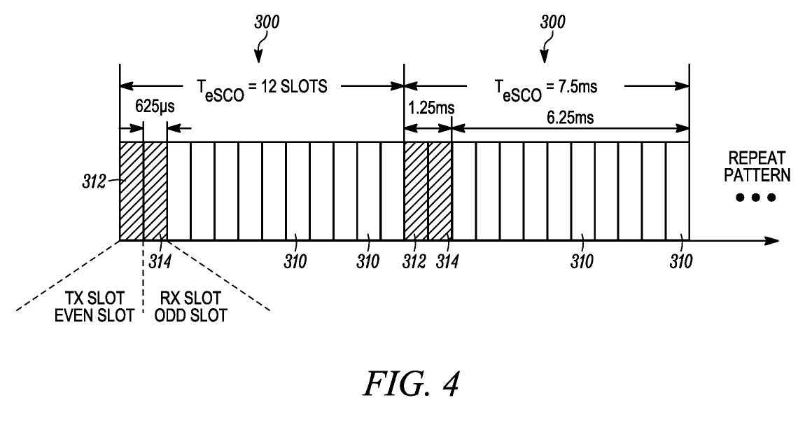

More recent Bluetooth profiles include the optional use of eSCO packet type 2-EV3. In view of a more efficient modulation scheme, a higher duty cycle can be used to carry the same 64 kbps speech of the SCO mode. Referring to FIG. 4, an example of a transmit/receive cycle 300 of 2-EV3 packets of a Bluetooth master device is shown. Here the cycle time (T_{eSCO}) of the cycle 300 is approximately 7.5 ms in duration and includes twelve slots 310, each being about 625 μs. One of the slots 310 is a transmission slot 312 and another is a receive slot 314. As can be seen, the total amount of idle time in the cycle time T_{eSCO} becomes 6.25 ms, which, as will be explained later, can help reduce the chances of collision with an 802.16 communication.

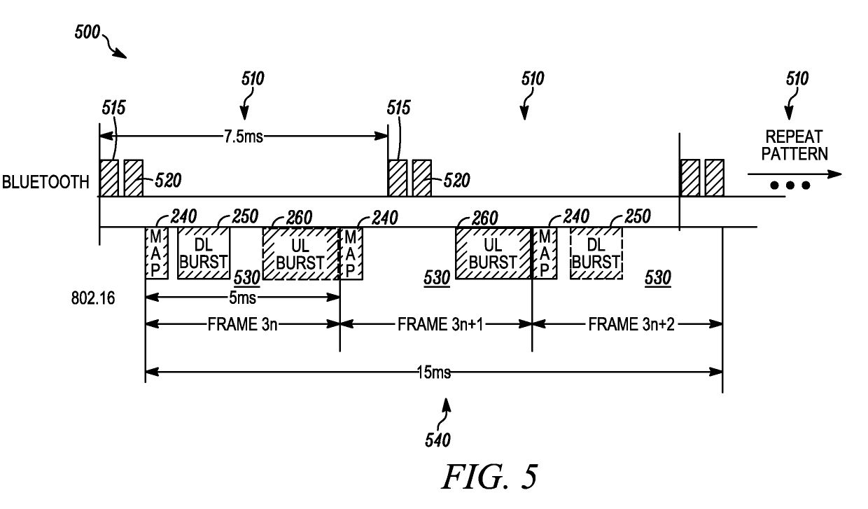

Referring to FIG. 5, an example of a suitable collision-free reference pattern 500 is shown. This pattern 500 shows Bluetooth cycles 510 that include transmission slots 515 and receive slots 520 and a cycle time of about 7.5 ms, similar to that shown in FIG. 4. In addition, the pattern 500 shows several listening frames 530 of an 802.16 communication, which are similar in structure to that shown in FIG. 3.

The three listening frames 530 together form a cluster of frames 540, which is roughly 15 ms in duration. As pictured here, the listening frames 530 may include a set-up portion 240, a DL burst 250 and/or an UL burst 260. Each listening frame 530 has been designated with a frame number. For example, the first listening frame 530 can be referred to as frame 3n, the second frame 530 can be referred to as frame 3n+1 and the third frame 530 can be designated as frame 3n+2. The value n refers to the number for the current cluster of frames 540. Although not shown here, the first frame 530 in the next cluster of frames 540 would be frame 3n+3 with each successive frame 530 given a higher number (e.g., 3n+4, 3n+5, . . . ). Similarly, the last frame 530 in the previous cluster of frames 540 would be frame 3n−1 with each previous frame given a lower number (e.g., 3n−2, 3n−3, . . . ).

In one arrangement, a single DL burst 250 and a single UL burst 260 may be allocated to the cluster of frames 540, which is, for example, sufficient for a VoIP transmission. In particular, in the 802.16 standard, certain UL scheduling service classes, such as unsolicited grant service (UGS) or extended real-time polling service (ertPS), support periodic allocation of an UL burst 260. Moreover, some base stations 110 may be configured to support periodic allocation of a DL burst 250. Because there are three frames 530 and single DL and UL bursts 250, 260 in a cluster of frames 540, there are several combinations that reflect where the DL and UL bursts 250, 260 may be allocated.

For example, one can see that a solid-line DL burst 250 has been allocated to frame 3n, while a solid-line UL burst 260 has been assigned to frame 3n+1. In view of the Bluetooth transmissions, it is apparent that no collisions will occur in this scenario. As another example, a dashed-line UL burst 260 may be positioned in frame 3n, while a dashed-line DL burst 250 can be in frame 3n+2. Again, the Bluetooth transmissions can be compatibly positioned around this particular allocation such that no collisions will occur. In addition to these two examples, there are several other allocations that will be described later, including how the Bluetooth transmissions can be arranged around them.

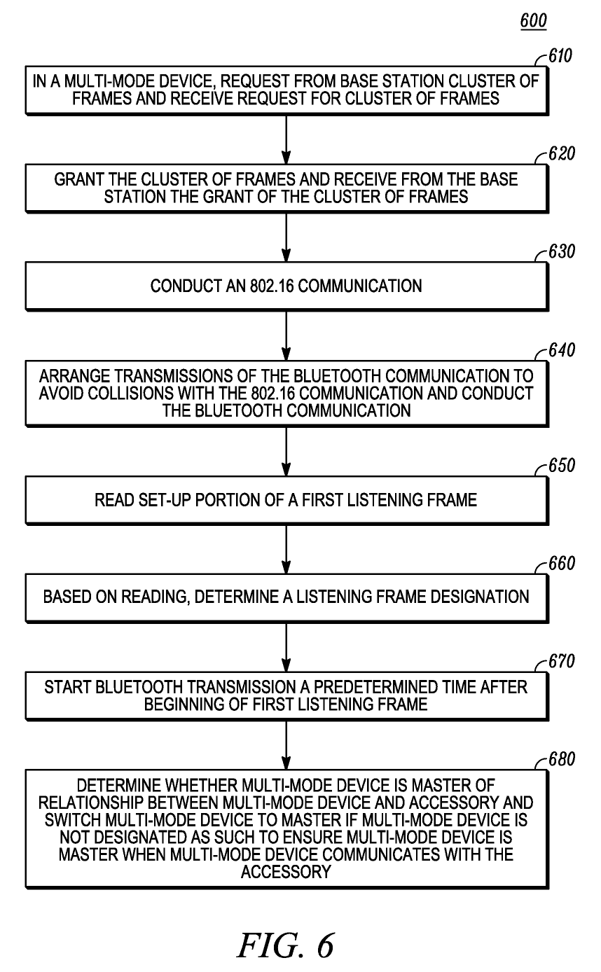

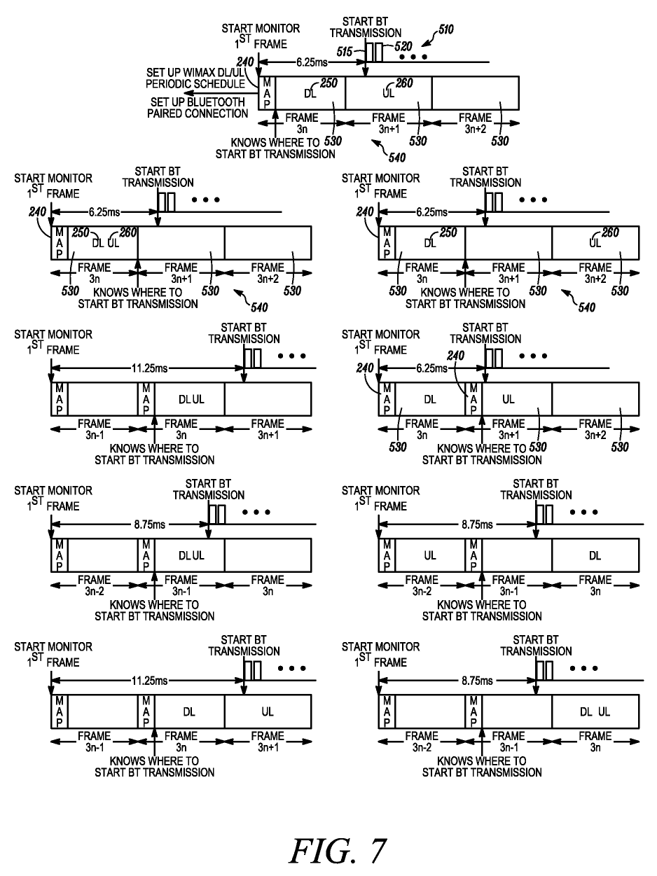

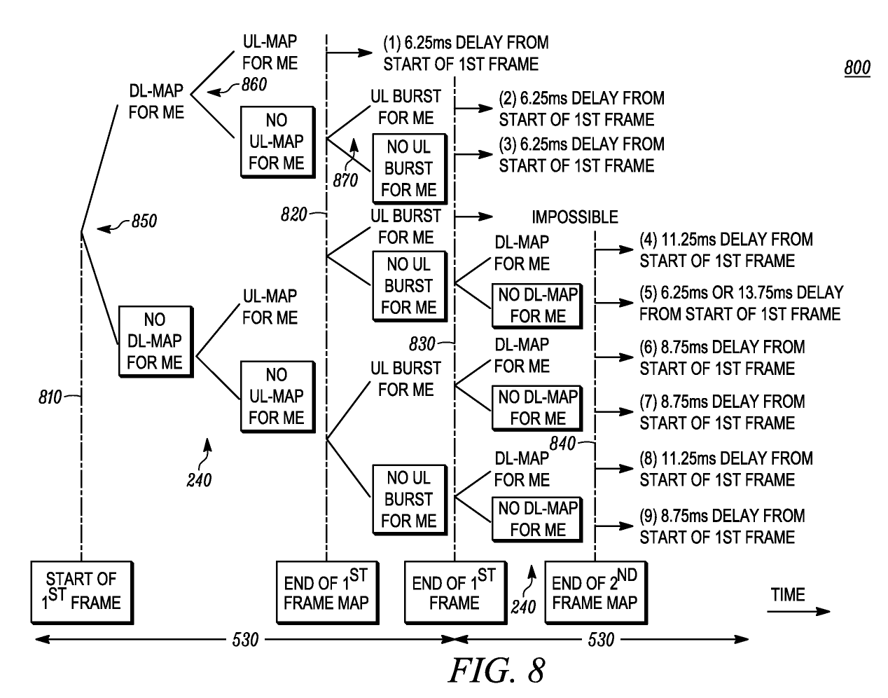

Referring to FIG. 6, a method 600 for collision avoidance is shown. When describing the method 600, reference will be made to FIGS. 1-5, although it is understood that the method 600 may be practiced in any other suitable system or device and in accordance with other transmission schemes. Reference will also be made to FIGS. 7 and 8, which respectively show certain decision points and a summary of these decision points. The steps of the method 600 are not limited to the particular order in which they are presented in FIG. 6. The inventive method can also have a greater number of steps or a fewer number of steps than those shown in FIG. 6.

At step 610, the multi-mode device 100 can request from the base station 110 a cluster of frames, and the base station 110 can receive this request. As an example, the cluster of frames can have a designated number of listening frames. At step 620, the base station 110 can grant the request for the cluster of frames, and the multi-mode device 100 can receive this grant. An 802.16 communication can then be conducted, as shown at step 630. As an example, the cluster of frames can include three listening frames, similar to that pictured in FIG. 5. As noted earlier, this type of communication may occur when a user wishes to conduct a VoIP call.

Referring back to the method 600 of FIG. 6, at step 640, transmissions of a Bluetooth communication can be arranged to avoid collisions with the transmission of the 802.16 communication. The Bluetooth communication may be necessary where a user initiates a Bluetooth accessory, such as accessory 120 of FIG. 1. For example, at step 650, a set-up portion of a first listening frame can be read, and based on this reading, a listening frame designation can be determined, as shown at step 660. At step 670, a Bluetooth transmission can be started a predetermined time after the beginning of the first listening frame.

Referring to FIG. 7, several examples are presented that show when a Bluetooth transmission can begin based on an 802.16 communication. While each of these scenarios presents a particular way to determine when to begin Bluetooth transmissions, the overall goal is the same: to avoid collisions between the Bluetooth and 802.16 communications, as reflected in the reference pattern 500 of FIG. 5.

Each example shows an initial Bluetooth transmission 510 having a transmit slot 515 and a receive slot 520. Also shown in these examples is a cluster of frames 540 including listening frames 530 that make up an 802.16 communication. Some of the listening frames 530 show a set-up portion 240 and some have received DL and UL burst 250, 260 allocations, depending on the scheduling performed by the base station 110 (see FIG. 1). Each of the listening frames 530 has been designated with a frame number, such as 3n, 3n+1, etc. Moreover, the first arrow pointing down shows where the multi-mode device 100 begins to read the first listening frame 530, and the second arrow pointing down reflects where the Bluetooth collision-free transmission may actually begin. The arrow pointing up indicates where the device 100 has determined when the Bluetooth transmission can begin.

Focusing on the first example (the number 1 in parentheses), the multi-mode device 100 can read the set-up portion 240 of the first listening frame 530. As evidenced by the arrow pointing up, the device 100, at the end of the set-up portion 240, can determine that a DL burst 250 has been allocated for the current listening frame 530 and that an UL burst 260 has been assigned to the next listening frame 530. As explained earlier, the base station 110 can be configured to allocate a single UL burst 260 and DL burst 250 for the three frames 530 that make up the cluster of frames 540. As such, the device 100 can determine that no burst 250, 260 is allocated to the last listening frame 530 in the cluster of frames 540.

Referring to the reference pattern 500 of FIG. 5, the device 100 can then determine that this particular cluster of frames 540 corresponds to the DL burst 250 being in frame 3n, the UL burst 260 being in frame 3n+1 and no allocations being in frame 3n+2. As such, the collision avoidance module 140 of the multi-mode device 100 can determine the positioning of the three listening frames 530 of the first example of FIG. 7, which is reflected in their designations (e.g., 3n, 3n+1, 3n+2). Based on the reference pattern 500 of FIG. 5, the collision avoidance module 140 can start the Bluetooth transmission approximately 6.25 ms after the start of the first listening frame 530, or frame 3n. In view of the cycle time of 7.5 ms for the Bluetooth transmission and the fixed periodicity of the DL burst 250 and UL burst 260 allocations, collisions between the Bluetooth and 802.16 communications can be avoided. Although not pictured, this particular positioning of the Bluetooth transmission will not interfere with the set-up portion 240 of the frame 3n+1. Even if the set-up portion 240 would extend beyond its normal allocation of roughly 1.25 ms, the device 100 can ignore this additional information, as it is already aware of the positioning of the DL and UL bursts 250, 260 for this and future clusters of frames 540.

Referring to the second scenario, the multi-mode device 100 can read the set-up portion 240 of the first listening frame 530 and can determine that the current frame 530 includes a DL burst 250. Although not part of the set-up portion 240 (see the set-up portion 240 in the previous frame 530), the device 100 can determine the existence of the UL bust 260 in the current frame 530. This particular configuration is also reflected in the reference pattern 500 of FIG. 5 (solid line DL burst and dashed-line UL burst in the first frame), and the collision avoidance module 140 can determine the designations of these particular frames 530 of this second example of FIG. 7, which in order is 3n, 3n+1 and 3n+2. Thus, as reflected by the up arrow, the collision avoidance module 140 can make this determination at the end of the first listening frame 530. Similar to the first example, the collision avoidance module 140 can initiate the Bluetooth transmission approximately 6.25 ms from the start of the first listening frame 530 (frame 3n) for collision-free communications.

Referring to the third scenario, the device 100 can determine that the first listening frame 530 includes a DL burst 250, that there are no allocations in the next listening frame 530 and that an UL burst 260 is in the following listening frame 530. In particular, in this example, the device 100 will not detect an UL burst 260 in the first frame 530, and the set-up portion 240 of this first frame 530 does not indicate that an UL burst 260 is present in the next listening frame 530. Through the process of elimination, the device 100 can determine that the UL burst 260 is in the last frame 530 of this particular cluster of frames 540. Referring to reference pattern 500, it can be seen that such a scenario exists in which an UL burst 260 is present in frame 3n+1 and a DL burst 250 is present in frame 3n+2. In view of the periodicity of this system, frame 3n+2 is equivalent to frame 3n−1. Thus, the order of the frames 530 in this third example of FIG. 7 is 3n−1, 3n and 3n+1. Based on this ordering, the device 100 can determine to begin the Bluetooth transmission about 11.25 ms after the start of the first listening frame 530.

As explained in these examples, the device 100 can read the first listening frame 530 and can determine the designation (e.g., 3n, 3n+1, 3n+2) of the listening frames 530 in the cluster of frames 540. Determining the designations can permit the device 100, in view of the reference pattern 500 of FIG. 5, to decide where to begin the Bluetooth transmission. In accordance with these principles, Bluetooth transmissions can begin approximately 11.25 ms after the start of the first listening frame 530 in examples (4) and (8); approximately 6.25 ms after the start of the first listening frame 530 in example (5); and approximately 8.75 ms after the start of the first listening frame 530 in examples (6), (7) and (9).

Referring to example (5), a possibility exists in which the Bluetooth transmission may begin approximately 13.75 ms after the start of the first listening frame 530, or frame 3n. Here, the multi-mode device 100 needs to read the set-up portion 240 of the next consecutive listening frame 530, and it will not know when to begin the Bluetooth transmission until the portion 240 is processed, as indicated by the up arrow. There is a chance that the portion 240 will extend beyond its normal allocation of 1.25 ms. In that case, it may be necessary to begin the Bluetooth transmission in the next suitable position to avoid any collisions, or 13.75 ms from the start of frame 3n.

Referring to FIG. 8, a summary chart 800 of the decision process illustrated by the examples of FIG. 7 is shown. The first broken, vertical line 810 of the chart 800 indicates the start of the first listening frame 530 in the cluster of frames 540, while the second broken, vertical line 820 represents the end of the set-up portion 240 of the first listening frame 530. The third broken, vertical line 830 shows the end of the first listening frame 530, and the last broken, vertical line 840 corresponds to the end of the set-up portion 240 of the next consecutive listening frame 530 in the cluster of frames 540.

The divergent line segments represent decision points in which line segments slanted in an upward direction indicate a “yes” or “affirmative” for the decision, while those segments in a downward direction signify a “no” or “negative” for the decision. In addition, the text “DL-MAP for me” and “UL-MAP for me” refers to the current set-up portion 240 respectively indicating that a DL burst allocation exists for the current listening frame 530 and that an UL burst allocation exists for the next listening frame 530. The blocks containing the text “No DL-MAP for me,” “No UL-MAP for me” or “No UL burst for me” respectively indicate that the current set-up portion 240 does not show any DL burst allocation for the current listening frame 530, does not show any UL burst allocation for the next consecutive listening frame 530 and does not show any UL burst in the current listening frame 530. The horizontal arrows point to numbers in parentheses that correspond to the examples presented in FIG. 7 and include the amount of time after the start of the first listening frame 530 at which the Bluetooth transmission will begin.

For example, at a first decision point 850, it can be determined that the set-up portion 240 indicates the presence of a DL burst in the current frame 530. Moving along the upward line segment to a second decision point 860, it can be determined that a UL burst allocation is in the next frame 530. This particular flow corresponds to the first example of FIG. 7 in which the Bluetooth transmission is approximately 6.25 ms from the start of the first frame 530.

Similarly, moving back to the second decision point 860, it may be determined that no UL burst allocation is present in the next frame 530. Moving along the downward line segment to a decision point 870, it can be determined that a UL burst allocation exists in the current frame 530. This decision process corresponds to the second example of FIG. 7, and as such, the Bluetooth transmission starts about 6.25 ms from the start of the first frame 530. Using this summary chart 800 for any allocation scenario, the time at which the Bluetooth transmission should begin to avoid collisions with the 802.16 communication can be determined.

In view of the above, collisions between an 802.16 communication and a Bluetooth communication can be avoided without affecting the quality of either transmission. Moreover, the arrangement of the Bluetooth communication does not require any onerous modifications. In fact, it is not necessary to develop a proprietary Bluetooth headset to facilitate this process, as it is fully supported as an optional feature by recent Bluetooth profiles. This invention is also compatible with various scheduling service classes, such as unsolicited grant service (UGS) and extended real-time polling service (ertPS).

Referring to FIG. 6 once again, at step 680, it can be determined whether the multi-mode device is the master of the relationship between the multi-mode device and the accessory. Also at step 680, the multi-mode device can be switched to the master if the multi-mode device is not designated as such to ensure that the multi-mode device is the master when the multi-mode device communicates with the accessory. As explained earlier, referring to FIG. 2, the device switching module 137 can initiate this process and can work with the switching module 160 of the accessory 120 to facilitate this switch.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for collision avoidance, comprising:
in a multi-mode device, conducting a communication in accordance with an 802.16 communications protocol, wherein the 802.16 communication protocol communication includes only listening frames;
conducting in the multi-mode device another communication in accordance with a Bluetooth communications protocol that supports extended synchronous connection-oriented mode;
arranging transmissions of the Bluetooth communication to avoid collisions with transmissions of the 802.16 communication.

2. The method according to claim 1, further comprising requesting from a base station that supports the 802.16 communication a cluster of frames having a designated number of the listening frames.

3. The method according to claim 2, further comprising receiving from the base station a grant of the cluster of frames, wherein the cluster of frames includes three listening frames, each being approximately five milli-seconds in duration.

4. The method according to claim 3, wherein the listening frames include a downlink subframe and an uplink subframe and the method further comprises receiving downlink burst and uplink burst allocations respectively in the downlink subframe and the uplink subframe of the listening frames.

5. The method according to claim 4, wherein the cluster of frames includes a single downlink burst allocation and a single uplink burst allocation, and the downlink and uplink burst allocations are periodically fixed for future clusters of frames.

6. The method according to claim 4, wherein the listening frames also include a set-up portion and arranging transmissions of the Bluetooth communication to avoid collisions with transmissions of the 802.16 communication comprises:
reading the set-up portion of a first listening frame;
based on this reading, determining a listening frame designation; and
starting the Bluetooth transmission a predetermined time after the beginning of the first listening frame.

7. The method according to claim 6, wherein the predetermined time is approximately 6.25 milli-seconds, approximately 8.75 milli-seconds, approximately 11.25 milli-seconds or approximately 13.75 milli-seconds.

8. The method according to claim 1, wherein the Bluetooth communication includes a cycle time of approximately 7.5 milli-seconds, of which approximately 1.25 milli-seconds is occupied by a transmission slot and a receive slot.

9. The method according to claim 1, wherein the multi-mode device communicates with an accessory over the Bluetooth communications protocol and the multi-mode device is designated as a master.

10. The method according to claim 9, further comprising:
determining whether the multi-mode device is the master of the relationship between the multi-mode device and the accessory; and
switching the multi-mode device to the master if the multi-mode device is not designated as such to ensure that the multi-mode device is the master when the multi-mode device communicates with the accessory.

11. A method for collision avoidance, comprising:
at a base station that supports 802.16 communications, receiving from a multi-mode device through an 802.16 communication a request for a cluster of frames having only a predetermined number of listening frames;
granting the request for the cluster of frames in which the cluster of frames includes three listening frames; and
allocating uplink bursts and downlink bursts in the listening frames of the cluster of frames to permit the multi-mode device to arrange the transmissions of an extended synchronous connection-oriented Bluetooth communication to avoid collisions with the 802.16 communication.

12. The method according to claim 11, wherein allocating the uplink and downlink bursts comprises allocating a single downlink burst allocation and a single uplink burst allocation in the cluster of frames, and the downlink and uplink burst allocations are periodically fixed for future clusters of frames.

13. A multi-mode device, comprising:
a transceiver capable of conducting an 802.16 communication having only listening frames;
a transceiver capable of conducting an extended synchronous connection-oriented Bluetooth communication; and
a collision avoidance module coupled to the first and second transceivers, wherein the collision avoidance module arranges transmissions of the Bluetooth transceiver to avoid collisions with transmissions of the 802.16 transceiver.

14. The multi-mode device according to claim 13, wherein the collision avoidance module requests from a base station that supports 802.16 communications a cluster of frames having a designated number of the listening frames.

15. The multi-mode device according to claim 14, wherein the 802.16 transceiver receives from the base station a grant of the cluster of frames, wherein the cluster of frames includes three listening frames, each being approximately five milli-seconds in duration.

16. The multi-mode device according to claim 15, wherein the listening frames include a downlink subframe and an uplink subframe and the 802.16 transceiver receives downlink burst and uplink burst allocations respectively in the downlink subframe and the uplink subframe of the listening frames.

17. The multi-mode device according to claim 16, wherein the cluster of frames includes a single downlink burst allocation and a single uplink burst allocation, and the downlink and uplink burst allocations are periodically fixed for future clusters of frames.

18. The multi-mode device according to claim 16, wherein the listening frames also include a set-up portion and the collision avoidance module arranges transmissions of the Bluetooth communication to avoid collisions with transmissions of the 802.16 communication by:
reading the set-up portion of a first listening frame;
based on this reading, determining a listening frame designation; and
starting the Bluetooth transmission a predetermined time after the beginning of the first listening frame.

19. The multi-mode device according to claim 16, wherein the predetermined time is approximately 6.25 milli-seconds, approximately 8.75 milli-seconds, approximately 11.25 milli-seconds or approximately 13.75 milli-seconds.

20. The multi-mode device according to claim 13, wherein the Bluetooth communication includes a cycle time of approximately 7.5 milli-seconds, of which approximately 1.25 milli-seconds is occupied by a transmission slot and a receive slot.

21. The multi-mode device according to claim 13, wherein the Bluetooth transceiver communicates with an accessory and the multi-mode device is designated as a master.

22. The multi-mode device according to claim 21, further comprising a device switching module, wherein the device switching module determines whether the multi-mode device is the master of the relationship between the multi-mode device and the accessory and switches the multi-mode device to the master if the multi-mode device is not designated as such to ensure that the multi-mode device is the master when the Bluetooth transceiver communicates with the accessory.

23. A base station that supports 802.16 communications, comprising:
a transceiver that receives from a multi-mode device through an 802.16 communication a request for a cluster of frames having only a designated number of listening frames; and
a generating module, wherein the generating module:
grants the request for the cluster of frames in which the cluster of frames includes three listening frames; and
allocates uplink bursts and downlink bursts in the listening frames of the cluster of frames to permit the multi-mode device to arrange the transmissions of an extended synchronous connection-oriented Bluetooth communication to avoid collisions with the 802.16 communication.

24. The base station according to claim 23, wherein allocating the uplink and downlink bursts comprises allocating a single downlink burst allocation and a single uplink burst allocation in the cluster of frames, and the downlink and uplink burst allocations are periodically fixed for future clusters of frames.
